(19) United States
(12) Patent Application Publication
(10) Pub. No.: US 2006/0136485 A1
(43) Pub. Date: Jun. 22, 2006

(54) Dynamic selection or modification of data management patterns

(76) Inventors: Peter Yared, San Francisco, CA (US); Jeffrey B. Norton, Pleasanton, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/281,268

(22) Filed: Nov. 16, 2005

Related U.S. Application Data
(60) Provisional application No. 60/628,644, filed on Nov. 16, 2004.

(51) Int. Cl. G06F 7/00

(52) U.S. Cl. 707/102

(57) ABSTRACT

Systems and methods are presented that enable the dynamic selection or modification of data management patterns (such as for caching or updating data). A deployment document describes how to manage data used by the application, including which caching patterns (and parameters) and which updating patterns should be used. In this way, a data management pattern can be specified for a particular application (and for a particular data type or data structure within an application), rather than a system-wide configuration option. The deployment document can be modified at any time up until the application starts being executed. A set of business policies and/or technical rules determines whether and how an application's deployment document should be modified. The policies and rules can take into account the application's run-time context, such as the type of transaction, the user involved, and the size and the longevity of the data needed and generated.

### CROSS-REFERENCE TO RELATED APPLICATION

This application claims priority from the following U.S. provisional patent application, which is hereby incorporated by reference: Ser. No. 60/628,644, filed on Nov. 16, 2004, entitled “Grid Application Server Employing Context-Aware Transaction Attributes.”

### BACKGROUND OF THE INVENTION

1. Field of the Invention

The present invention relates to patterns for managing data, such as caching data and updating data. In particular, the invention relates to dynamically modifying a data management pattern.

2. Description of Background Art

In client-server systems, servers are often used to provide resources needed by the clients, such as data. When a client needs data, it establishes a connection with a server and issues a request to retrieve the data. Later, the client might also issue a request to update the data. As the number of clients in the system increases, the number of requests to servers also increases. Eventually, the servers can become bottlenecks, which decreases client performance.

One way to avoid this bottleneck is by caching data on a client (“client-side caching”). This way, if a client needs data, it can try to retrieve it from its local cache. If the data is not present in the local cache, the client can retrieve it from elsewhere. “Elsewhere” can be, for example, a server or another client. Caching data on multiple clients is sometimes referred to as aggregate, distributed, or co-operative caching. When data is cached on multiple clients and one client wants to update data, it can write the updated data through to the server and/or notify other clients that the data has been updated.

Data management, including caching and updating, can be performed in various ways. For example, if a client experiences a local cache miss, it can try to retrieve the data from the local cache of another client before contacting a server. If a client notifies other clients that data has been updated, the notification may or not may not include the updated data itself.

While many different data management patterns exist, only one data management pattern can be specified for each client. This can be inefficient when one client executes many different types of applications, each of which uses data in a different way. What is needed is a way to dynamically select or modify a data management pattern.

### SUMMARY OF THE INVENTION

Systems and methods are presented that enable the dynamic selection or modification of data management patterns (such as for caching or updating data). In one embodiment, these systems and methods are used in conjunction with an application server infrastructure. The application server infrastructure includes a transaction grid (made of application servers), various network data stores, and a network connecting them. An application includes one or more XML documents that are used by a run-time module to execute the application.

In one embodiment, data accessed by the application is defined by one or more XML Schema documents as a particular Complex Type. An application includes a deployment document that describes how to manage data used by the application, including which caching patterns (and parameters) and which updating patterns should be used for which Complex Types. In this way, a data management pattern can be specified for a particular application (and for a particular data type or data structure within an application), rather than as a system-wide configuration option.

In one embodiment, an application's deployment document can be changed at run-time. For example, an application is deployed by loading its definition documents onto an application server. These documents can then be changed at any time up until the run-time module begins executing the application.

In one embodiment, a set of business policies and/or technical rules determines whether and how an application's deployment document should be modified. The policies and rules can take into account the application's run-time context, such as the type of transaction, the user involved, and the size and the longevity of the data needed and generated.

### BRIEF DESCRIPTION OF THE DRAWINGS

The invention is illustrated by way of example, and not by way of limitation, in the figures of the accompanying drawings in which like reference numerals refer to similar elements.

FIG. 1 illustrates a block diagram of an application server infrastructure, according to one embodiment of the invention.

FIG. 2 illustrates a block diagram of the application server infrastructure of FIG. 1, but with a more detailed view of one of the nodes, according to one embodiment of the invention.

### DETAILED DESCRIPTION OF THE EMBODIMENTS

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to an apparatus for performing the operations herein. This apparatus is specially constructed for the required purposes, or it comprises a general-purpose computer selectively activated or reconfigured by a computer program stored in the computer. Such a computer program is stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems are used with programs in accordance with the teachings herein, or more specialized apparatus are constructed to perform the required method steps. The required structure for a variety of these systems will appear from the description below. In addition, the present invention is not described with reference to any particular programming language. It will be appreciated that a variety of programming languages may be used to implement the teachings of the invention as described herein.

1. Application Server Infrastructure

Below, systems and methods are described that enable the dynamic selection or modification of a data management pattern (such as for caching or updating data). The description focuses on a client-server system architecture. In particular, the “clients” are nodes that act as application servers, and the “servers” are network data stores. The client-server architecture, including its use for application servers, is merely exemplary and is not necessary to take advantage of dynamic selection or modification of data management patterns. Any environment that uses data management patterns can use these systems and methods to dynamically select or modify the data management pattern that is used.

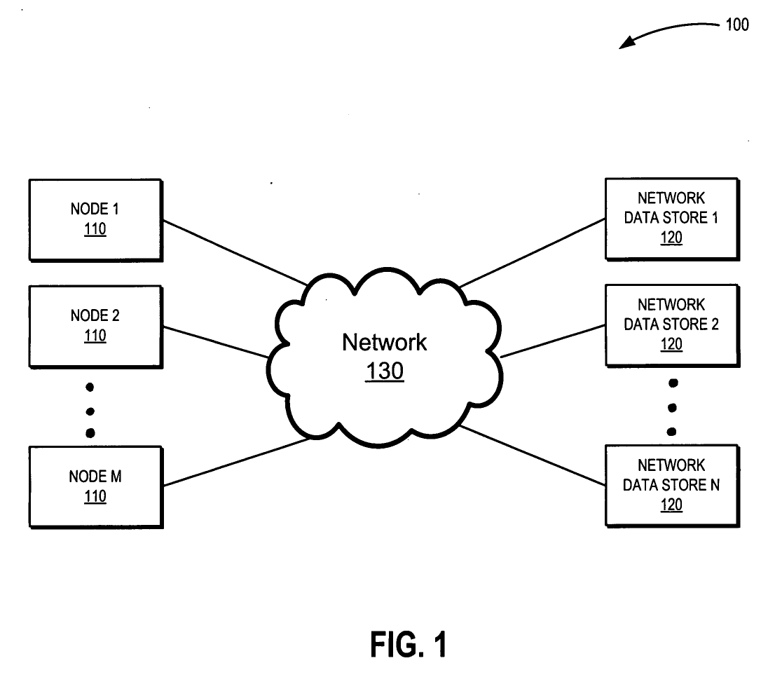

FIG. 1 illustrates a block diagram of an application server infrastructure, according to one embodiment of the invention. The application server infrastructure 100 includes various nodes 110, various network data stores 120, and a network 130. The various nodes 110 are communicatively coupled to the various network data stores via the network 130. The nodes 110 and the network data stores 120 represent groups of functionality and can be implemented in only hardware, only software, or a mixture of both. In addition, while they are illustrated as separate modules in FIG. 1, the functionality of multiple modules can be implemented in a single hardware device.

In one embodiment, the various nodes 110 are application servers. The number of nodes 110 is anywhere from one to over one thousand. Together, the nodes 110 comprise a transactions grid (or cluster) of machines. In one embodiment, a node 110 comprises a computer that includes off-the-shelf, commodity hardware and software. For example, the hardware is based on an x86 processor. The software includes the LAMP stack, which includes a Linux operating system (available from, for example, Red Hat, Inc., of Raleigh, N.C.), an Apache HyperText Transfer Protocol (HTTP) server (available from The Apache Software Foundation of Forest Hill, Md.), a MySQL database (available from MySQL AB of Sweden), and support for scripts written in languages such as Perl, PHP, and Python.

A network data store comprises a data repository of any kind. The data repository includes, for example, one or more file systems and/or database systems (of any type, such as relational, object-oriented, or hierarchical). Example databases include PostgreSQL (available from the PostgreSQL Global Development Group at http://www.postgresql.org/), MySQL (available from MySQL AB of Sweden), SQLite (available from Hwaci—Applied Software Research of Charlotte, N.C.), Oracle databases (available from Oracle Corp. of Redwood Shores, Calif.), and DB2 databases (available from International Business Machines Corp. of Armonk, N.Y.). The number of network data stores 120 is generally much smaller than the number of nodes 110.

In one embodiment, the network 130 is a partially public or a wholly public network such as the Internet. The network 130 can also be a private network or include one or more distinct or logical private networks (e.g., virtual private networks or wide area networks). Additionally, the communication links to and from the network 130 can be wireline or wireless (i.e., terrestrial- or satellite-based transceivers). In one embodiment of the present invention, the network 130 is an IP-based wide or metropolitan area network.

In one embodiment, an application executed by one or more nodes in the transaction grid is created using a declarative application programming model. For example, an application includes one or more documents written using eXtensible Markup Language (XML). In one embodiment, an application includes Business Process Execution Language (BPEL) documents that define the application's control flow and XML Schema documents that define data accessed by the application.

In another embodiment, an application includes Web Services Description Language (WSDL) documents. In one embodiment, a WSDL document defines a web service used by the application, possibly including stored procedures contained in a database used by the application. In another embodiment, a WSDL document includes one or more XML Schema documents that define the data model used by the service described in the WSDL. In yet another embodiment, a WSDL document defines an XML Schema more generally that can be used by the application to access any type of data.

A run-time module executes an application based on these various XML document definitions. In one embodiment, the run-time module includes an XML parser such as one that implements the Simple API for XML (SAX) interface.

Since an application is a collection of definitions, an application's behavior can be modified by changing the definitions. In one embodiment, one or more of these definitions can be changed at run-time. For example, an application is deployed to a node 110 by loading the definitions onto the node. These definitions can be changed at any time up until the run-time module begins executing the application.

In one embodiment, a set of business policies and/or technical rules determines whether and how an application's definitions should be modified. The policies and rules can take into account the application's run-time context, such as the type of transaction, the user involved, and the size and the longevity of the data needed and generated.

2. Data Management

In one embodiment, XML Schemas are used to represent data sources or data objects (“data access object types”). For example, an XML Schema Definition (XSD) represents a data access object type as an XML Schema Complex Type. Object types are defined by application programmers and can include, for example, a Customer, an Order, or an Account. A Complex Type describes the data items it includes (e.g., name, address, and account number) and relationships between itself and other Complex Types in the schema (e.g., multiple line items for an order or multiple orders for a customer).

In one embodiment, an application includes a deployment document. A deployment document describes how to manage data used by the application, including which caching patterns and which updating patterns should be used for which Complex Types in the XML Schema. In this way, a data management pattern can be specified for a particular application (and for a particular data type or data structure within an application), rather than as a system-wide configuration option.

An application's deployment document can be modified at any time up until the application started. In particular, a deployment document can be modified even after an application has been deployed (for example, loaded onto a node 110). Different caching patterns and updating patterns are suitable for different situations. This is why it is useful to define a business policy or technical rule that determines, based on an application's context, which caching pattern and/or updating pattern to use.

Below is an XML Document Type Definition (DTD) for a deployment document:

```
<?xml version=“1.0” encoding=“UTF-8”?>
<!ELEMENT ag:deployment (ag:datasource+, ag:schemaref+)>
<!ATTLIST ag:deployment
    xmlns:ag CDATA #REQUIRED
    sessionPersistence CDATA #REQUIRED
>
<!ELEMENT ag:datasource (ag:dsn, ag:password, ag:username)>
<!ATTLIST ag:datasource
    name (Oracle_ds1 | mySQLpetstore_ds1) #REQUIRED
    dbtype (MySQL | Oracle) #REQUIRED
    maxPooledConnections CDATA #REQUIRED
>
<!ELEMENT ag:dsn (#PCDATA)>
<!ELEMENT ag:password (#PCDATA)>
<!ELEMENT ag:username (#PCDATA)>
<!ELEMENT ag:schemaref (ag:datasourcename, ag:cache+)>
<!ATTLIST ag:schemaref
    name CDATA #REQUIRED
    filePath CDATA #REQUIRED
>
<!ELEMENT ag:cache (ag:size, ag:datasourcename, ag:expiration,
ag:updateFrequency, ag:updatePhase)>
<!ATTLIST ag:cache
    pattern (OnDemand-Node | OnDemand-Grid | TimedPull-Node |
TimedPull-Grid | Partitioned | PartitionedTimedPull | InPlace-Session |
InPlace-Node | InPlace-Grid) #REQUIRED
    updatePattern (Distributed | Write-thru | Invalidate) #REQUIRED
    ref CDATA #REQUIRED
>
<!ELEMENT ag:size EMPTY>
<!ATTLIST ag:size
    bytes CDATA #IMPLIED
    items CDATA #IMPLIED
>
<!ELEMENT ag:datasourcename (#PCDATA)>
<!ELEMENT ag:expiration (#PCDATA)>
<!ELEMENT ag:updateFrequency (#PCDATA)>
<!ELEMENT ag:updatePhase (#PCDATA)>
```

The schemaref element indicates the XML Schema used by the application. The cache element describes the data management patterns to be used. Each Complex Type in an XML Schema (represented in the DTD by a cache element's ref attribute) can have a different cache element. The example deployment document below includes two cache elements, one for a Product Complex Type and one for an Account Complex Type.

The cache element also includes a pattern attribute, whose value specifies the caching pattern to be used, and an updatepattern attribute, whose value specifies the updating pattern to be used. In the illustrated embodiment, there are nine possible caching patterns (OnDemand-Node, OnDemand-Grid, TimedPull-Node, Timedpull-Grid, Partitioned, PartitionedTimedPull, InPlace-Session, InPlace-Node, and InPlace-Grid) and three possible updating patterns (Distributed, Write-thru, and Invalidate). Note that the cache element can include various parameters, such as size, datasourcename, expiration, updateFrequency, and updatephase, each of which is also an element. Each of these patterns and parameters will be explained below.

Below is an example deployment document according to the above DTD:

```
<?xml version=“1.0” encoding=“UTF-8”?>
<ag:deployment xmlns:ag=“http://www.activegrid.com/ag.xsd”
sessionPersistence=“MEMORY”>
  <ag:datasource name=“mySQLpetstore” dbtype=“MySQL”
maxPooledConnections=“1”>
    <ag:dsn></ag:dsn>
    <ag:password></ag:password>
    <ag:username></ag:username>
  </ag:datasource>
  <ag:schemaref name=“petstore.xsd” filePath=“petstore.xsd”>
    <ag:datasourcename>mySQLpetstore</ag:datasourcename>
    <ag:cache pattern=“TimedPull” updatePattern=“Write-thru”
    ref=“Product”>
      <ag:updateFrequency>1440</ag:updateFrequency>
      <ag:updatePhase>120</ag:updatePhase>
    </ag:cache>
    <ag:cache pattern=“OnDemand-Grid” updatePattern=“Write-thru”
ref=“Account”>
      <ag:expiration>360</ag:expiration>
    </ag:cache>
  </ag:schemaref>
</ag:deployment>
```

This deployment document indicates the following: The application uses the XML Schema “petstore.xsd.” The Product Complex Type is cached using the TimedPull pattern and updated using the Write-thru pattern. Parameters include an updateFrequency of 1440 and an updatePhase of 120. The Account Complex Type is cached using the OnDemand-Grid pattern and updated using the Write-thru pattern. Parameters include an expiration of 360.

A. Caching Patterns

Data described by a Complex Type can be cached on one or more nodes 110 according to various caching patterns. In one embodiment, these caching patterns fall into four categories: OnDemand, TimedPull, Partitioned, and InPlace.

In one embodiment, OnDemand caching patterns include OnDemand-Node and OnDemand-Grid. In these caching patterns, data is cached on every node 110. The caches are populated on demand. For example, once an application has obtained data, the data is cached. The difference between OnDemand-Node and OnDemand-Grid is what happens when a node 110 experiences a local cache miss. In OnDemand-Node, a local cache miss is resolved by retrieving data from a network data store 120. In OnDemand-Grid, a local cache miss is resolved first by attempting to obtain the data from another node 110. If this is unsuccessful, the data is retrieved from a network data store 120.

In one embodiment, TimedPull caching patterns include TimedPull-Node and TimedPull-Grid. In these caching patterns, data is cached on every node 110. The caches are populated on a schedule. For example, caches are populated periodically whether or not applications have requested the data. The difference between TimedPull-Node and TimedPull-Grid is how much data is cached in each node 110. In TimedPull-Node, a node 110 caches the entire data set for a Complex Type. Since the entire data set is cached, a local cache miss cannot occur. In TimedPull-Grid, a node 110 caches a portion of the data set for a Complex Type. A local cache miss is resolved first by attempting to obtain the data from another node 110. If this is unsuccessful, the data is retrieved from a network data store 120.

In one embodiment, Partitioned caching patterns include Partitioned and PartitionedTimedPull. In these caching patterns, a node 110 caches a portion of the data set for a Complex Type. A local cache miss is resolved first by attempting to obtain the data from another node 110. If this is unsuccessful, the data is retrieved from a network data store 120. The difference between Partitioned and PartitionedTimedPull is how the cache is populated. In Partitioned, the cache is populated on demand. In PartitionedTimedPull, the cache is populated on a schedule.

In one embodiment, InPlace caching patterns include InPlace-Session, InPlace-Node, and InPlace-Grid. In these caching patterns, a node 110 caches a query and its results. The difference between InPlace-Session, InPlace-Node, and InPlace-Grid is the availability of locally cached data. In InPlace-Session, locally cached data is specific to a user and is thus available for requests involving the same user but is not available for requests involving other users or requests originating from other nodes 110. In InPlace-Node, locally cached data is specific to a node 110 and is thus available for requests involving the same user and for requests involving other users but is not available for requests originating from other nodes 110. In InPlace-Grid, locally cached data is available for requests involving the same user, for requests involving other users, and for requests originating from other nodes 110. A cache miss is resolved first by attempting to obtain the data from another node 110. If this is unsuccessful, the data is retrieved from a network data store 120.

Each of these caching patterns can be configured differently by modifying various parameters. In one embodiment, caching parameters fall into four categories: Cache Sizing, Data Consistency, Update Frequency, and Update Phase. Cache Sizing parameters specify details about the local cache. A local cache can include, for example, Random Access Memory (RAM), a hard disk, or a database. Different parameters are available depending on the type of local cache. For a RAM cache, parameters include the number of bytes to allocate to the RAM cache and the number of data items to cache. For a database cache, parameters include the name of the database, the number of bytes to allocate to the database cache, and the number of data items to cache. Cache Sizing parameters are available for all types of caching patterns except for TimedPull-Node, since this caching pattern stores, by definition, the entire data set for a Complex Type.

Data Consistency parameters specify details about the validity of cached data, such as its expiration date (e.g., the time after which it is no longer valid). Data Consistency parameters are available for all types of caching patterns except for those involving a timed pull (both those in the TimedPull category and PartitionedTimedPull), since these caching patterns obtain data from a network data store 120, which always contains valid data (by definition).

Update Frequency and Update Phase parameters specify details about timed pull caching patterns (both those in the TimedPull category and PartitionedTimedPull), such as the length of time between updates of the data set and an offset from the initial update time. (Assigning different offsets to different nodes 110 helps prevent nodes from updating their data sets simultaneously and creating bottlenecks at network data stores 120.)

B. Updating Patterns

Data described by a Complex Type can be updated according to various updating patterns. In one embodiment, these updating patterns include Write-thru, Invalidate, and Distributed.

In one embodiment, in the Write-thru updating pattern, when a node 110 updates cached data, it writes the updated data through to a network data store 120. Other nodes can become aware of this update in two ways. First, they can experience a local cache miss and retrieve data from the node 110 with the updated data. Alternatively, they can experience a local cache miss and retrieve data from the network data store 120 or refresh their cached data via a timed pull from the network data store 120. In one embodiment, Write-thru is the default updating pattern and can be combined with the Invalidate or Distributed updating patterns.

In one embodiment, in the Invalidate updating pattern, when a node 110 updates cached data, the corresponding data on other nodes 110 is invalidated. When the other nodes 110 need this data, they will experience a local cache miss (or already have the updated data, if they are using timed pulls). In one embodiment, in the Distributed updating pattern, when a node 110 updates cached data, it broadcasts the updated data to other nodes 110.

Some data management patterns are particularly useful. These include 1) OnDemand-Node with Invalidate, 2) InPlace-Node with Invalidate, 3) OnDemand-Node with Distributed, and 4) InPlace-Node with Distributed.

3. Node Details

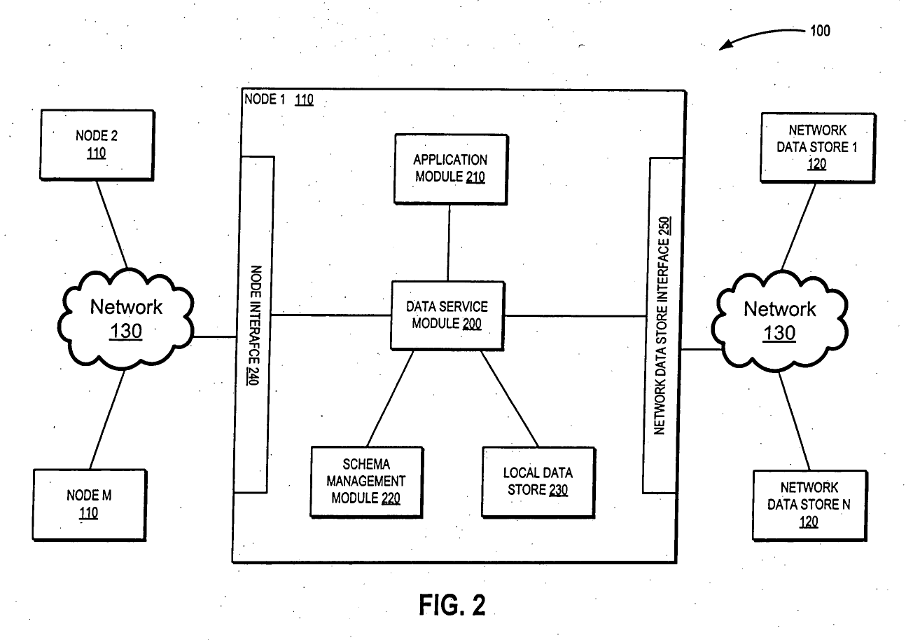

FIG. 2 illustrates a block diagram of the application server infrastructure of FIG. 1, but with a more detailed view of one of the nodes, according to one embodiment of the invention. A node 110 includes a data service module 200, an application module 210, a schema management module 220, a local data store 230, a node interface 240, and a network data store interface 250. The data service module 200 is communicatively coupled to the application module 210, the schema management module 220, the local data store 230, the node interface 240, and the network data store interface 250. These modules and interfaces represent groups of functionality and can be implemented in only hardware, only software, or a mixture of both. In addition, while they are illustrated as separate modules in FIG. 2, the functionality of multiple modules can be implemented in a single software application or hardware device.

The data service module 200 receives requests from applications for data. When the data service module 200 receives a request, it uses the schema management module 220 to determine the Complex Type that represents the data. The data service module 200 then obtains the data according to the caching pattern specified in the application's deployment document (for example, using the local data store 230, the node interface 240, or the network data store interface 250). After obtaining the data, the data service module 200 uses the schema management module 220 to obtain an object of the appropriate Complex Type and instantiates it using the data. The instantiated object is then returned to the application that requested it.

The application module 210 generates requests for data and sends these requests to the data service module 200. In one embodiment, the application module 210 includes a run-time module that executes an application according to various definition documents, such BPEL and XML Schemas.

The schema management module 220 uses an application's XML Schema document to determine the Complex Type that represents a set of data. The schema management module 220 also creates an object instance that represents the Complex Type.

The local data store 230 is used as the node's cache. The local data store 230 can include, for example, RAM, a disk, or a database.

The node interface 240 is used to communicate with other nodes 110. In one embodiment, data is obtained from a node 110 by sending that node an HTTP GET request. In one embodiment, the node interface 240 acts as a distributed cache manager. In other words, the node interface 240 can determine, for a given Complex Type, which nodes 110 contain data for that Complex Type. The node interface 240 can then retrieve the data from that node 110.

Together, node interfaces 240 from various nodes 110 combine to form a single cache manager. A request to the node interface 240 of any node 110 will find the data if it exists in any node 110, whether or not the node with the data is the node that received the request.

In one embodiment, a node interface's cache management functionality is implemented by using a hash table. A key in the hash table represents a Complex Type, and the associated value represents which nodes 110 contain data for that Complex Type. In another embodiment, a node interface's cache management functionality is implemented by using broadcast requests. When a node interface 240 is asked for a Complex Type, it sends a request to all of the other nodes 110. The Complex Type (for example, in its local data store 230) sends it to the requesting node 110 as a reply to the broadcast request.

The network data store interface 250 is used to communicate with a network data store 120.

In one embodiment (not shown), a node 110 also includes a timed pull management module that is communicatively coupled to the data service module 200. The timed pull management module enables the node 110 to use a timed pull caching pattern. The timed pull management module loads data into the local data store 230 and updates it periodically. At the appropriate time, the timed pull management module directs the data service module 200 to obtain updated data and store it in the local data store 230.

Although the invention has been described in considerable detail with reference to certain embodiments thereof, other embodiments are possible as will be understood to those skilled in the art.

1. (canceled)

2. A system for managing data used by an application executing on a first node, comprising:
a local data store;
an interface to a network data store;
an interface to a second node;
a set of instructions that indicates how the data is to be managed; and
a data management module configured to manage the data based on the set of instructions.

3. The system of claim 2, wherein the set of instructions further indicates how a particular data type is to be managed, and wherein the data management module is further configured to manage the particular data type based on the set of instructions.

4. The system of claim 2, wherein the set of instructions further indicates how a particular data structure is to be managed, and wherein the data management module is further configured to manage the particular data structure based on the set of instructions.

5. The system of claim 2, wherein the set of instructions is associated with the application.

6. The system of claim 2, wherein the set of instructions includes extensible Markup Language.

7. The system of claim 2, wherein the set of instructions includes an extensible Markup Language Schema document.

8. The system of claim 2, wherein the first node includes a Linux operating system.

9. The system of claim 2, wherein the first node includes a HyperText Transfer Protocol server.

10. The system of claim 2, wherein the local data store includes a database.

11. The system of claim 2, wherein the network data store includes a database.

12. A system for managing data used by an application executing on a first node, comprising:
a local data store;
an interface to a network data store;
an interface to a second node;
a set of instructions that indicates how the local data store is to be populated; and
a data management module configured to populate the local data store based on the set of instructions.

13. The system of claim 12, wherein the set of instructions further indicates that the local data store is to be populated on demand.

14. The system of claim 12, wherein the set of instructions further indicates that the local data store is to be populated on a schedule.

15. A system for managing data used by an application executing on a first node, comprising:
a local data store;
an interface to a network data store;
an interface to a second node;
a set of instructions that indicates how the data is to be obtained, if the data is not present in the local data store; and
a data management module configured to obtain the data, if the data is not located in the local data store, based on the set of instructions.

16. The system of claim 15, wherein the set of instructions further indicates that the data is to be obtained using the interface to the network data store.

17. The system of claim 15, wherein the set of instructions further indicates that the data is to be obtained using the interface to the second node.

18. A system for managing data used by an application executing on a first node, comprising:
a local data store;
an interface to a network data store;
an interface to a second node;
a set of instructions that indicates how data in the local data store is to be updated; and
a data management module configured to update data in the local data store based on the set of instructions.

19. The system of claim 18, wherein the set of instructions further indicates that data in the local data store is to be sent using the interface to the network data store.

20. The system of claim 18, wherein the set of instructions further indicates that data in the local data store is to be sent using the interface to the second node.

21. A computer-readable medium comprising instructions for managing data used by an application executing on a first node, comprising:
a local data store;
an interface to a network data store;
an interface to a second node;
a set of instructions that indicates how the data is to be managed; and
a data management module configured to manage the data based on the set of instructions.
